(19) United States
(12) Patent Application Publication
(10) Pub. No.: US 2021/0365888 A1
(43) Pub. Date: Nov. 25, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Makoto KUREBAYASHI, Kanagawa (JP)

(73) Assignee: FUJIFILM BUSINESS INNOVATION CORP., Tokyo (JP)

(21) Appl. No.: 17/123,284

(22) Filed: Dec. 16, 2020

(30) Foreign Application Priority Data
May 20, 2020 (JP) 2020-088058

(51) Int. Cl. G06Q 10/10; G06F 3/0482

(52) U.S. Cl. CPC G06Q 10/103; G06F 3/0482

(57) ABSTRACT

An information processing apparatus includes a processor configured to: perform control in such a way as to display a workflow image indicating a series of processes included in a workflow and a list of data to be processed in the workflow; and cause, in a case where a piece of data is selected on the list of data, the workflow image to reflect a progress state of processing of the selected piece of data.

### CROSS-REFERENCE TO RELATED APPLICATIONS

This application is based on and claims priority under 35 USC 119 from Japanese Patent Application No. 2020-088058 filed May 20, 2020.

### BACKGROUND

### (i) Technical Field

The present disclosure relates to an information processing apparatus and a non-transitory computer readable medium.

### (ii) Related Art

Techniques for displaying a workflow are known. In Japanese Unexamined Patent Application Publication No. 2013-242880, for example, a technique for causing a client to display order of activities in a workflow and select operators to perform the activities. In Japanese Unexamined Patent Application Publication No. 2007-102706, a technique for displaying, in a workflow, information regarding an execution state of a process performed on a document in each of individual boxes in which the process is defined.

### SUMMARY

A plurality of pieces of data might be independently processed in the same workflow. In order to display processes included in the workflow and the pieces of data to be processed in the workflow, a list of the pieces of data to be processed in the workflow is sometimes displayed in a screen along with an image indicating the processes included in the workflow. Because a progress state of processing differs between different pieces of data, for example, a method in which, if one of the processes included in the workflow is selected on the screen in which the image indicating the processes included in the workflow and the list of the pieces of data to be processed in the workflow are displayed, a piece of data to be processed in the selected process is displayed is possible as a method for displaying the progress state of processing of each of the pieces of data to be processed in the workflow. With this method, however, it is difficult to visually recognize the progress state of processing of each of the pieces of data.

Aspects of non-limiting embodiments of the present disclosure relate to indication of a progress state of processing of each of pieces of data as well as processes included in a workflow in a screen in which an image indicating the processes included in the workflow and a list of pieces of data that are being processed in the workflow are displayed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: perform control in such a way as to display a workflow image indicating a series of processes included in a workflow and a list of data to be processed in the workflow; and cause, in a case where a piece of data is selected on the list of data, the workflow image to reflect a progress state of processing of the selected piece of data.

### BRIEF DESCRIPTION OF THE DRAWINGS

Exemplary embodiments of the present disclosure will be described in detail based on the following figures, wherein:

FIG. 1 is a diagram illustrating an example of the configuration of a workflow system according to a first exemplary embodiment;

FIG. 2 is a diagram illustrating an example of the configuration of a server apparatus according to the first exemplary embodiment;

FIG. 3 is a diagram illustrating an example of workflow information according to the first exemplary embodiment;

FIG. 4 is a diagram illustrating an example of the configuration of a terminal apparatus according to the first exemplary embodiment;

FIG. 5 is a sequence chart illustrating an example of an operation performed by the workflow system according to the first exemplary embodiment;

FIG. 6 is a diagram illustrating an example of a workflow screen according to the first exemplary embodiment;

FIG. 7 is a flowchart illustrating an example of a process for updating the workflow screen according to the first exemplary embodiment;

FIG. 8 is a diagram illustrating an example of the updated workflow screen according to the first exemplary embodiment;

FIG. 9 is a diagram illustrating an example of workflow information according to a second exemplary embodiment;

FIG. 10 is a diagram illustrating an example of a workflow screen according to the second exemplary embodiment;

FIG. 11 is a flowchart illustrating an example of a process for updating the workflow screen according to the second exemplary embodiment;

FIG. 12 is a diagram illustrating an example of the updated workflow screen according to the second exemplary embodiment;

FIG. 13 is a diagram illustrating another example of the updated workflow screen according to the second exemplary embodiment;

FIG. 14 is a diagram illustrating another example of the updated workflow screen according to the second exemplary embodiment; and

FIG. 15 is a diagram illustrating another example of the updated workflow screen according to the second exemplary embodiment.

### DETAILED DESCRIPTION

### 1. First Exemplary Embodiment

### 1.1 Configuration

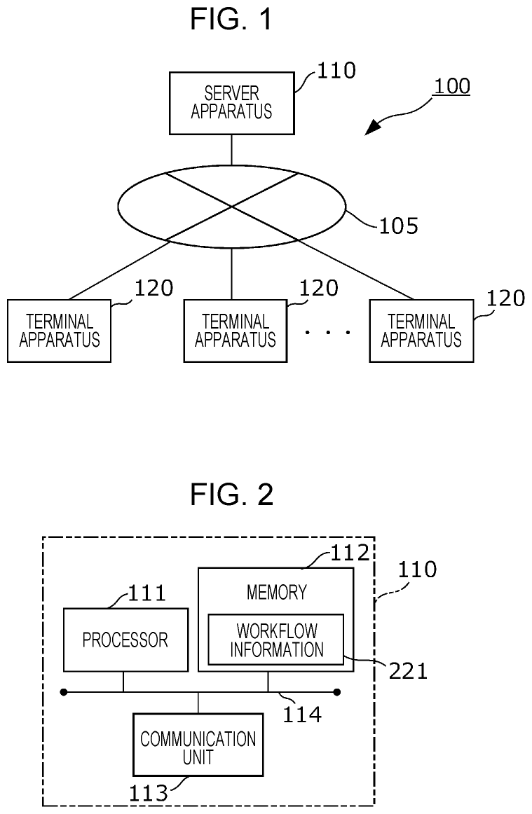

FIG. 1 is a diagram illustrating an example of the configuration of a workflow system 100 according to a first exemplary embodiment. The workflow system 100 enables a user to visually recognize a workflow. A “workflow” refers to a series of operations to be sequentially performed. The workflow includes a series of processes. Data to be processed is input to the workflow. In each of the processes included in the workflow, input data is sequentially processed. These processes include, for example, accumulation, sharing, approval, numbering, retrieval, processing, reviewing, application, and disclosure. When the series of processes included in the workflow is completed, processed data is output from the workflow. Plural pieces of data might be input to a workflow. In this case, these pieces of data are independently processed in the workflow. At this time, these pieces of data may be processed in parallel with each other in the workflow. The workflow system 100 includes a server apparatus 110 and terminal apparatuses 120. These apparatuses are connected to one another over a communication network 105. The Internet or a local area network (LAN), for example, is used as the communication network 105.

FIG. 2 is a diagram illustrating an example of the configuration of the server apparatus 110 according to the first exemplary embodiment. The server apparatus 110 has a function of providing a screen including a workflow to the terminal apparatus 120. The server apparatus 110 is an example of an information processing apparatus in the present disclosure. The server apparatus 110 includes a processor 111, a memory 112, and a communication unit 113. These components are connected to one another by a bus 114. The processor 111 executes a program to control the components of the server apparatus 110 and perform processing for achieving functions of the server apparatus 110. A central processing unit (CPU), for example, is used as the processor 111. The memory 112 stores the program for achieving the functions of the server apparatus 110, workflow information 221 indicating a workflow, and data to be processed in the workflow. The data may be document data indicating a document, for example, and created by a registerer using the terminal apparatus 120 or an image processing apparatus (not illustrated). A read-only memory (ROM) and a random-access memory (RAM), for example, are used as the memory 112. The memory 112 may also include a storage device such as a hard disk drive or a solid-state drive (SSD). The communication unit 113 communicates data with other apparatuses connected over the communication network 105. The communication unit 113 includes a communication interface connected to the communication network 105.

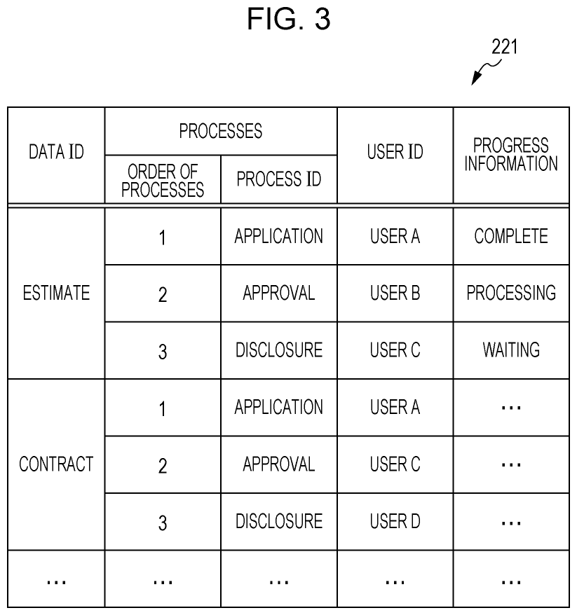

FIG. 3 is a diagram illustrating an example of the workflow information 221 according to the first exemplary embodiment. The workflow information 221 includes data identifiers (IDs), processes, user IDs, and progress information. The data IDs are information for uniquely identifying data input to a workflow. In the example illustrated in FIG. 3, an estimate and a contract are input to the workflow as data. The processes indicate a series of processes included in the workflow. The processes include order of processes and process IDs. The order of processes indicates order in which the processes included in the workflow are to be performed. The process IDs are information for uniquely identifying the processes included in the workflow. In the example illustrated in FIG. 3, the workflow includes an application process, in which data is applied for, an approval process, in which the application for the data is approved, and a disclosure process, in which the data is disclosed. The application process, the approval process, and the disclosure process are performed in this order. The user IDs are information for uniquely identifying operators who are to perform the processes included in the workflow. Operators are determined in advance by the registerer for each piece of data. That is, even with the same process, an operator might be different depending on the piece of data. In the case of the estimate in the example illustrated in FIG. 3, an operator who is to perform the application process is user A, an operator who is to perform the approval process is user B, and an operator who is to perform the disclosure process is user C. In the case of the contract, on the other hand, an operator who is to perform the application process is user A, an operator who is to perform the approval process is user C, and an operator who is to perform the disclosure process is user D. Here, user C performs the disclosure process for the estimate but performs the approval process for the contract. A process to be performed by each user might thus be different between different pieces of the data. The progress information indicates a progress state of each of the processes included in the workflow. The progress state can be “complete”, “processing”, or “waiting”. “Complete” indicates that the process has been completed. “Processing” indicates that the process is currently being performed. “Waiting” indicates that the process has not yet been performed. The progress information is updated as the process progresses. When the process is completed, for example, the progress information is updated in accordance with an operation performed by a corresponding operator.

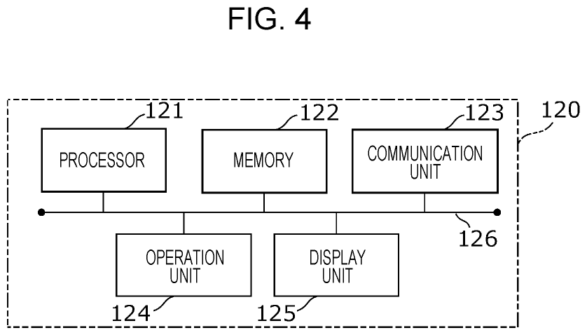

FIG. 4 is a diagram illustrating an example of the configuration of the terminal apparatus 120 according to the first exemplary embodiment. The terminal apparatus 120 is used by a user such as an operator or a registerer. The terminal apparatus 120 has a function of displaying a screen including a workflow. The terminal apparatus 120 includes a processor 121, a memory 122, a communication unit 123, an operation unit 124, and a display unit 125. These components are connected to one another by a bus 126. The processor 121 executes a program to control the components of the terminal apparatus 120 and achieve functions of the terminal apparatus 120. A CPU, for example, is used as the processor 121. The memory 122 stores the program for achieving the functions of the terminal apparatus 120. A ROM and a RAM, for example, are used as the memory 122. The memory 122 may also include a storage device such as a hard disk drive or an SSD. The communication unit 123 communicates data with other apparatuses connected over the communication network 105. The communication unit 123 includes a communication interface connected to the communication network 105. The operation unit 124 is used to operate the terminal apparatus 120. A mouse and a keyboard, for example, are used as the operation unit 124. The display unit 125 displays various screens used to communicate information with the user. A liquid crystal display, for example, is used as the display unit 125.

### 1.2 Operation

When the processor 111 or 121 performs processing in the following description, the processing is achieved by performing arithmetic processing or controlling the operation of other hardware elements using the processor 111 or 121 through cooperation between the program stored in the memory 112 or 122 and the processor 111 or 121, which executes the program.

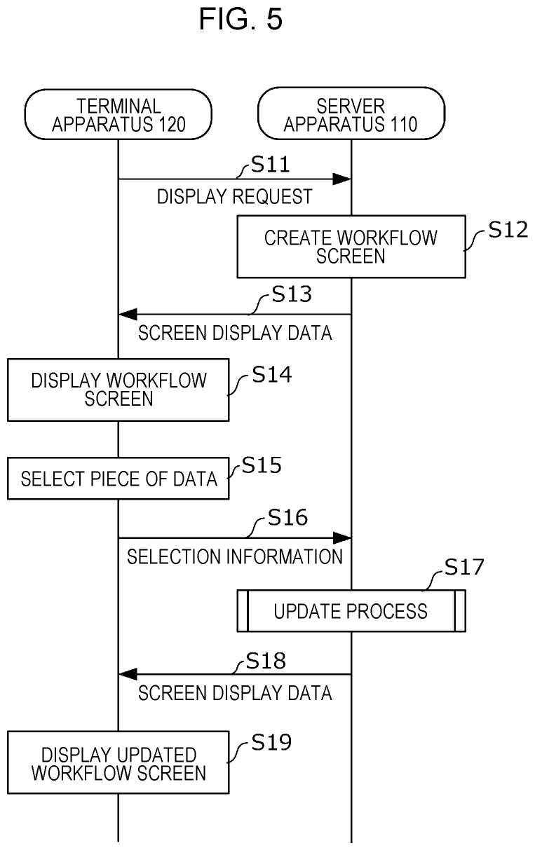

FIG. 5 is a sequence chart illustrating an example of an operation performed by the workflow system 100 according to the first exemplary embodiment. The operation starts when the user uses a workflow. In step S11, the processor 121 of the terminal apparatus 120 transmits a request to display a workflow to the server apparatus 110 in accordance with an operation performed by the user. The request includes a user ID of the user. It is assumed here that the user ID of the user is “user C”. The processor 111 of the server apparatus 110 receives the request from the terminal apparatus 120 and, in step S12, creates a workflow screen 130 including the workflow on the basis of the workflow information 221 stored in the memory 112. The user ID included in the request is stored in the memory 112. The workflow screen 130 may be created in advance, instead.

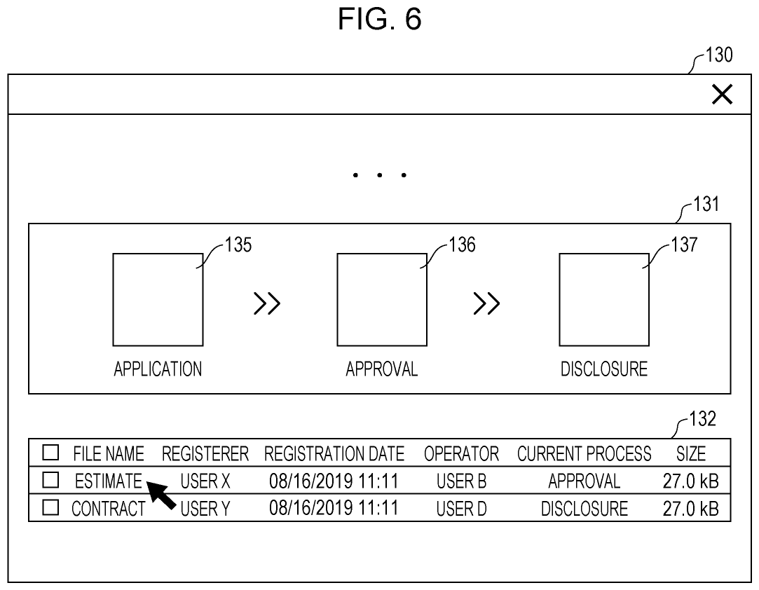

FIG. 6 is a diagram illustrating an example of the workflow screen 130 according to the first exemplary embodiment. The workflow screen 130 includes a workflow image 131 and a data list 132. That is, the workflow image 131 and the data list 132 are included in a single screen. The workflow image 131 indicates the processes of the workflow indicated by the workflow information 221. The processes include the order of processes included in the workflow. In the example illustrated in FIG. 3, the workflow includes the application process, the approval process, and the disclosure process, which are performed in this order. In this case, the workflow image 131 includes an icon 135 indicating the application process, an icon 136 indicating the approval process, and an icon 137 indicating the disclosure process. That is, the workflow image 131 is an image obtained by combining the icons 135 to 137 together. The icons 135 to 137 are arranged from left to right in FIG. 6 in accordance with the order in which the application process, the approval process, and the disclosure process are to be performed. The data list 132 is a list of data to be processed in the workflow indicated by the workflow information 221. In the example illustrated in FIG. 3, the data to be processed in the workflow includes an estimate and a contract. In this case, as illustrated in FIG. 6, the data list 132 includes list information regarding the data including the estimate and the contract. The list information includes, for example, file names of the data, names of registerers of the data, dates of registration of the data, names of operators who are to process the data, names of processes currently being performed on the data, and the size of the data.

In step S13, the processor 111 transmits screen display data for displaying the workflow screen 130 to the terminal apparatus 120 to control the terminal apparatus 120 such that the terminal apparatus 120 displays the workflow screen 130. Upon receiving the image display data from the server apparatus 110, the processor 121 of the terminal apparatus 120 displays, in step S14, the workflow screen 130 on the display unit 125 in accordance with the image display data. The workflow screen 130 illustrated in FIG. 6, for example, is displayed on the display unit 125.

After the terminal apparatus 120 displays the workflow screen 130, the user performs an operation for selecting a desired piece of data from the data list 132 using the operation unit 124. The operation is, for example, an operation for moving the mouse over information regarding the desired piece of data. If the user performs the operation for selecting a piece of data in step S15, the processor 121 of the terminal apparatus 120 transmits, in step S16, selection information, which indicates the selected piece of data, to the server apparatus 110. It is assumed here that the user has selected the estimate. In this case, the processor 121 transmits selection information indicating the estimate.

Upon receiving the selection information from the terminal apparatus 120, the processor 111 of the server apparatus 110 performs, in step S17, a process for updating the workflow screen 130 on the basis of the data indicated by the selection information and the workflow information 221 and the user IDs stored in the memory 112. In the process, the workflow image 131 reflects a progress state of processes for the selected piece of data. In addition, an icon indicating a process to be performed by the user is highlighted. The process to be performed by the user is an example of a target process in the present disclosure. The icon indicating the process to be performed by the user is an example of a target part in the present disclosure.

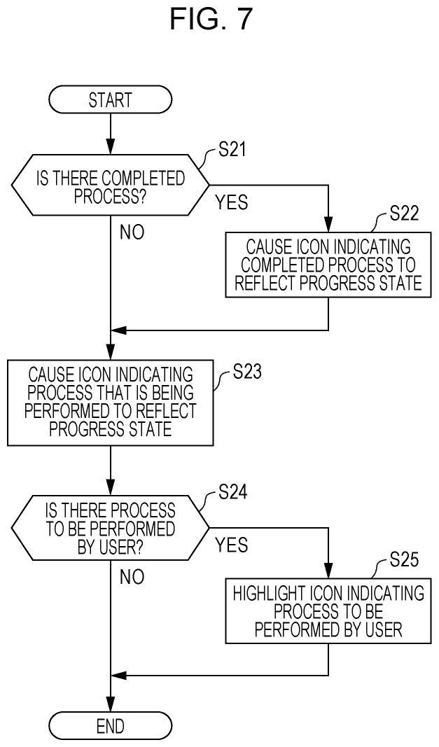

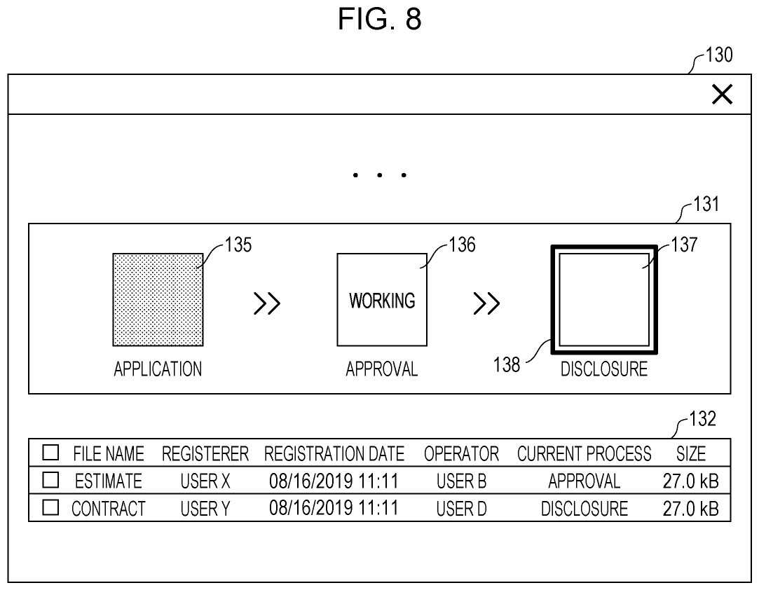

FIG. 7 is a flowchart illustrating an example of the process for updating the workflow screen 130 according to the first exemplary embodiment. FIG. 8 is a diagram illustrating an example of the workflow screen 130 updated through the process. In step S21, the processor 111 determines whether there is a process that has been completed for the selected piece of data. As described above, it is assumed here that the estimate has been selected. As illustrated in FIG. 3, for example, if progress information indicates that a progress state of the application process is “complete” among the processes for the estimate, the processor 111 determines that there is a process that has been completed for the selected piece of data (YES in step S21). If determining that there is a process that has been completed for the selected piece of data, the processor 111 causes the process to proceed to step S22.

In step S22, the processor 111 causes an icon indicating the process that has been completed to reflect the progress state of the process. If the progress state of the application process for the estimate indicates “complete” as described above, for example, the icon 135 indicating the application process is grayed out as illustrated in FIG. 8 so that the icon 135 becomes inconspicuous.

If determining in the above-described step S21 that there is no process that has been completed for the selected piece of data (NO in step S21), on the other hand, the processor 111 causes the process to proceed to step S23 while skipping step S22. In step S23, the processor 111 causes an icon indicating a process that is being performed for the selected piece of data to reflect a progress state of the process. If the progress information indicates that a progress state of the approval process for the estimate is “processing” as illustrated in FIG. 3, for example, a word “working”, which indicates that the approval process is being performed, is added to the icon 136 indicating the approval process as illustrated in FIG. 8.

In step S24, the processor 111 determines whether there is a process to be performed by the user for the selected piece of data. As described above, it is assumed here that the user ID of the user is “user C”. In the example illustrated in FIG. 3, the user whose user ID is “user C” is an operator who is to perform the disclosure process for the estimate. In this case, the processor 111 determines that there is a process to be performed by the user for the selected piece of data (YES in step S24). If determining that there is a process to be performed by the user for the selected piece of data, the processor 111 causes the process to proceed to step S25.

In step S25, the processor 111 changes the icon indicating the process to be performed by the user such that the icon is highlighted. As described above, it is assumed in the example illustrated in FIG. 3 that the process to be performed by the user whose user ID is “user C” is the disclosure process. In this case, as illustrated in FIG. 8, a red solid frame 138 is added to the icon 137 indicating the disclosure process. The process for updating the workflow screen 130 ends after step S25.

If determining in the above-described step S24 that there is no process to be performed by the user (NO in step S24), on the other hand, the processor 111 ends the process for updating the workflow screen 130 without performing step S25. When the process for updating the workflow screen 130 ends, the process illustrated in FIG. 5 resumes.

In step S18, the processor 111 transmits screen display data for displaying the workflow screen 130 updated in the above-described process to the terminal apparatus 120 to control the terminal apparatus 120 such that the terminal apparatus 120 displays the updated workflow screen 130. Upon receiving the screen display data from the server apparatus 110, the processor 121 of the terminal apparatus 120 displays, in step S19, the updated workflow screen 130 on the display unit 125 in accordance with the screen display data. For example, the workflow screen 130 illustrated in FIG. 8 is displayed on the display unit 125. In the workflow screen 130, the workflow image 131 reflects progress states of the application process, the approval process, and the disclosure process for the estimate selected by the user. The icon 137 indicating the disclosure process, which is to be performed by the user for the estimate, is highlighted by the red solid frame 138.

Here, if the user performs an operation for selecting another piece of data on the data list 132, the process for updating the workflow screen 130 is performed for the other piece of data, and the updated workflow screen 130 is displayed. If the user selects a contract, for example, the workflow image 131 that reflects progress states of an application process, an approval process, and a disclosure process for the contract is displayed. In the example illustrated in FIG. 3, a process to be performed by user C for the contract is the approval process. In this case, the red solid frame 138 is added to the icon 136 indicating the approval process to highlight the icon 136.

According to the first exemplary embodiment, the workflow screen 130 includes both the workflow image 131 and the data list 132. Processes included in a workflow and a progress state of each of the processes, therefore, are visually recognized from the workflow screen 130. In addition, if the user selects a piece of data from the data list 132, the workflow image 131 that reflects the progress states of the processes for the selected piece of data is displayed. The user, therefore, recognizes progress states of processes for each piece of data. Furthermore, if the user selects a piece of data from the data list 132, an icon indicating a process to be performed by the user for the selected piece of data is highlighted. Even if a process to be performed by the user differs between pieces of data, therefore, the user recognizes the process to be performed for each piece of data.

### 2. Second Exemplary Embodiment

Some workflows branch at some point in accordance with a branch condition. For example, a workflow might branch in accordance with an amount of money input by an operator at a branch point. If the input amount of money is larger than or equal to 100,000 yen, for example, a process proceeds to a certain branch, and if the input amount of money is smaller than 100,000 yen, the process proceeds to another branch. In addition, a workflow might branch in accordance with a determination made by an operator who is performing an operation at a branch point. If the operator selects a certain branch, for example, a process proceeds to the certain branch, and if the user selects another branch, the process proceeds to the other branch. In such a workflow, operations and operators after a branch point differ depending on a selected branch. In the second exemplary embodiment, an image indicating a workflow that branches at some point is displayed such that the user visually recognizes the workflow. At this time, the image indicating the workflow reflects confirmation states of branches.

The configuration of a workflow system 100 according to the second exemplary embodiment is basically the same as that of the workflow system 100 according to the first exemplary embodiment. The memory 112 of the server apparatus 110, however, stores workflow information 222 instead of the workflow information 221.

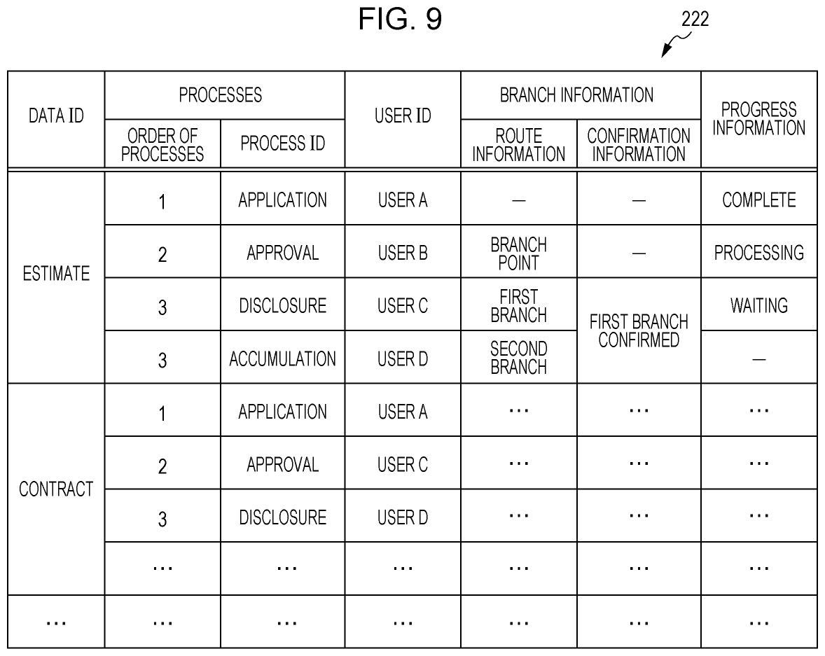

FIG. 9 is a diagram illustrating an example of the workflow information 222 according to the second exemplary embodiment. The workflow information 222 includes branch information as well as data IDs, processes, user IDs, and progress information, which are included in the workflow information 221 according to the first exemplary embodiment. The branch information is information regarding branching of workflows. The branch information includes route information and confirmation information. The route information indicates branch points and branches. In the example illustrated in FIG. 9, a workflow branches in an approval process into a first branch including a disclosure process and a second branch including an accumulation process. The confirmation information indicates confirmation states of the branches. A confirmation state of a branch can be an unconfirmed state or a confirmed state. Until a branch to be followed is confirmed, for example, the confirmation information indicates that a branch to be followed has not been confirmed. If a first branch is confirmed as the branch to be followed, on the other hand, the confirmation information indicates that the first branch has been confirmed as the branch to be followed. The confirmation information is updated in accordance with a confirmation state of the branch to be followed. The confirmation information is updated, for example, in accordance with an operation performed by an operator who has confirmed the branch to be followed or information input from the terminal apparatus 120 when the branch to be followed has been confirmed.

The operation of the workflow system 100 according to the second exemplary embodiment is different from that of the workflow system 100 according to the first exemplary embodiment in terms of a process for updating a workflow screen. The same operations as in steps S11 to S16 described in the first exemplary embodiment are performed between the terminal apparatus 120 and the server apparatus 110. As a result, a workflow screen 140 is displayed on the display unit 125 of the terminal apparatus 120.

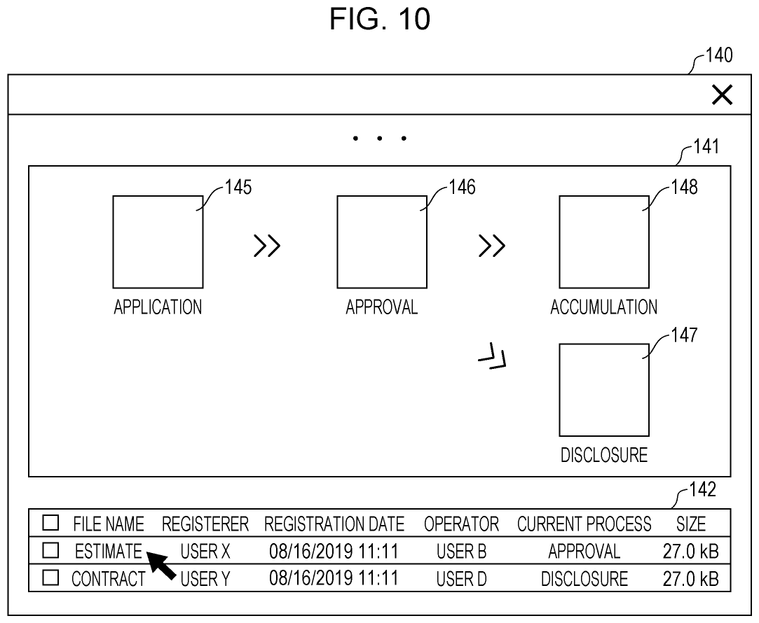

FIG. 10 is a diagram illustrating an example of the workflow screen 140 according to the second exemplary embodiment. The workflow screen 140 includes, as with the workflow screen 130 according to the first exemplary embodiment, a workflow image 141 and a data list 142. The workflow image 141 indicates, as with the workflow image 131 included in the workflow screen 130 according to the first exemplary embodiment, processes included in a workflow indicated by the workflow information 222. In the example illustrated in FIG. 9, the workflow includes an application process, an approval process, a disclosure process, and an accumulation process. In this case, the workflow image 141 includes an icon 145 indicating the application process, an icon 146 indicating the approval process, an icon 147 indicating the disclosure process, and an icon 148 indicating the accumulation process. In the example illustrated in FIG. 9, the workflow branches in the approval process into a first branch including the disclosure process and a second branch including the accumulation process. In this case, the icons 145 to 148 are arranged in order of execution of the application process, the approval process, the disclosure process, and the accumulation process. For example, the icons 145, 146, and 148 are horizontally arranged from left to right in FIG. 10, and the icons 147 and 148 are vertically arranged in FIG. 10. The data list 142 indicates, as with the data list 132 included in the workflow screen 130 according to the first exemplary embodiment, a list of data to be processed in the workflow indicated by the workflow information 222.

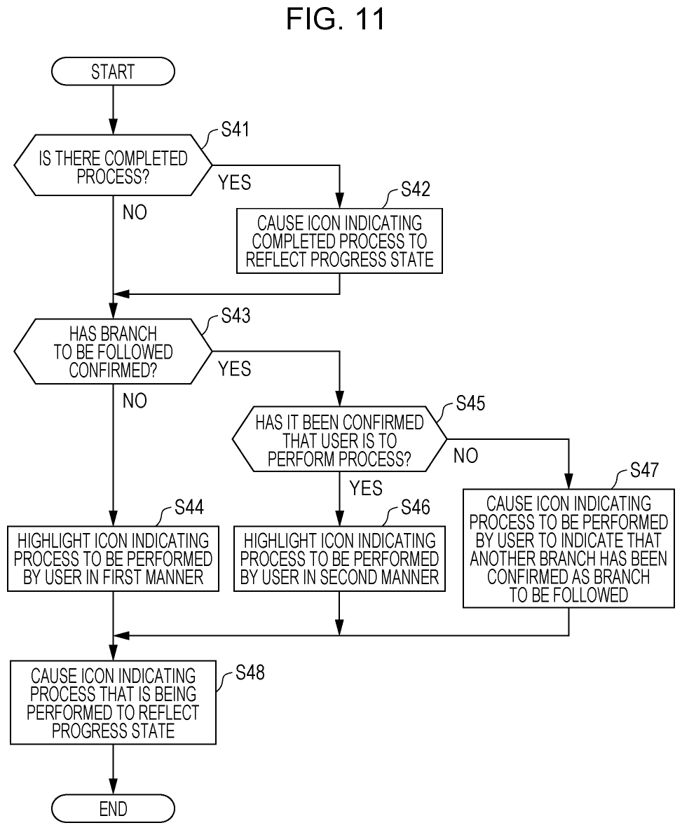

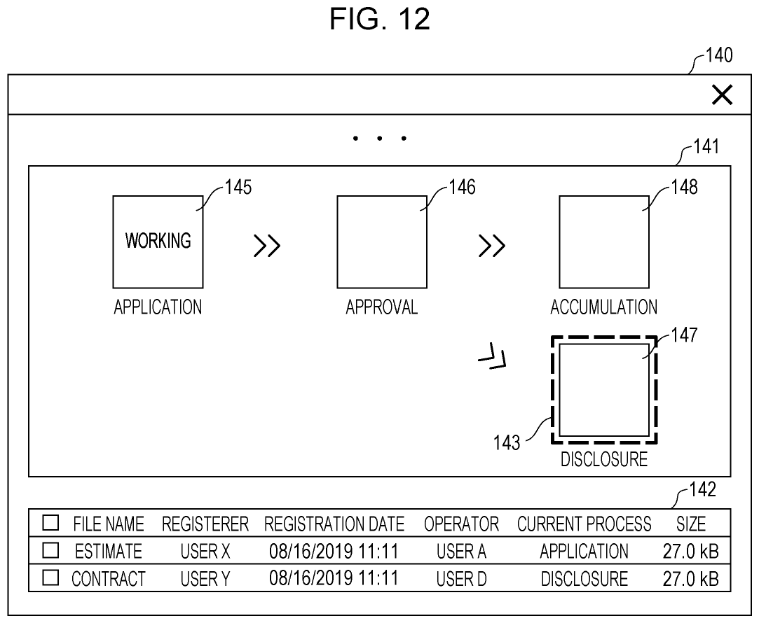

FIG. 11 is a flowchart illustrating an example of a process for updating the workflow screen 140 according to the second exemplary embodiment. FIGS. 12 to 15 are diagrams illustrating examples of the workflow screen 140 updated in the process. In the second exemplary embodiment, an icon indicating a process to be performed by the user is displayed differently between when the branch to be followed has not been confirmed, when a branch including the process to be performed by the user has been confirmed as the branch to be followed, and when a branch that does not include the process to be performed by the user has been confirmed as the branch to be followed.

Steps S41 and S42 are the same as steps S21 and S22, respectively, described in the first exemplary embodiment. In step S43, the processor 111 of the server apparatus 110 determines whether the branch to be followed has been confirmed. It is assumed here that, as in the first exemplary embodiment, the user has selected an estimate. Because the branch to be followed has not been confirmed before the approval process, which is the branch point, is reached in a workflow for processing the estimate, for example, confirmation information in the workflow information 222 indicates that the branch to be followed has not been confirmed in the workflow for processing the estimate. In this case, the processor 111 determines that the branch to be followed has not been confirmed (NO in step S43), the processor 111 causes the process to proceed to step S44.

In step S44, the processor 111 changes the icon indicating the process to be performed by the user such that the icon is highlighted in a first manner. It is assumed here that, as in the first exemplary embodiment, the user ID of the user is “user C”. In the example illustrated in FIG. 9, the process to be performed by user C for the estimate is the disclosure process. In this case, as illustrated in FIG. 12, a red broken frame 143 is added to the icon 147 indicating the disclosure process.

When the approval process, which is the branch point, is reached in the workflow for processing the estimate, for example, the branch to be followed in the workflow is confirmed. If a first branch is confirmed as the branch to be followed in the workflow, for example, the confirmation information is updated in such a way as to indicate that the first branch has been confirmed as the branch to be followed as illustrated in FIG. 9. In this case, the processor 111 determines in the above-described step S43 that the branch to be followed has been confirmed (YES in step S43) and causes the process to proceed to step S45. In step S45, the processor 111 determines whether it has been confirmed that the user is to perform the process. The branch including the process to be performed by the user is an example of a target branch in the present disclosure. As described above, it is assumed here that the first branch has been confirmed as the branch to be followed in the workflow for processing the estimate. In the example illustrated in FIG. 9, the first branch includes the disclosure process to be performed by user C. In this case, the processor 111 determines that it has been confirmed that the user is to perform the process (YES in step S45) and causes the process to proceed to step S46.

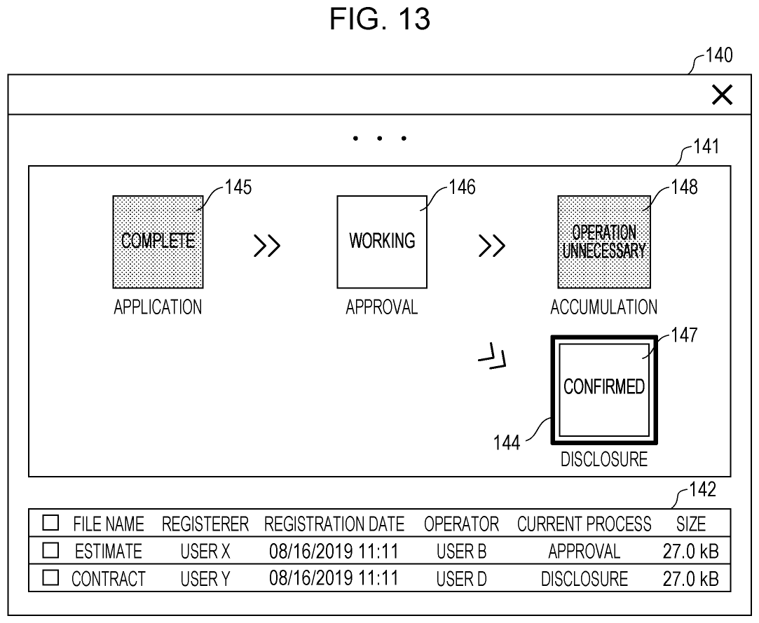

In step S46, the processor 111 changes the icon indicating the process to be performed by the user such that the icon is highlighted in a second manner. The highlighting in the second manner is stronger than the highlighting in the first manner. In the example illustrated in FIG. 9, the process to be performed by user C for the estimate is the disclosure process. In this case, as illustrated in FIG. 13, a red solid frame 144 is added to the icon 147 indicating the disclosure process, and a word “confirmed”, which indicates that it has been confirmed that the user is to perform the process, is added to the icon 147. The icon 148 indicating the accumulation process included in the second branch, which is different from the first branch, is grayed out so that the icon 148 becomes inconspicuous, and words “operation unnecessary”, which indicate that the process is not to be performed, are added to the icon 148.

If the second branch is confirmed as the branch to be followed in the workflow, on the other hand, the confirmation information is updated in such a way as to indicate that the second branch has been confirmed as the branch to be followed. In the example illustrated in FIG. 9, the second branch does not include the disclosure process, which is to be performed by user C, and includes the accumulation process, which is to be performed by another user. In this case, the processor 111 determines in the above-described step S45 that it has been confirmed that the user is not to perform the process (NO in step S45) and causes the process to proceed to step S47.

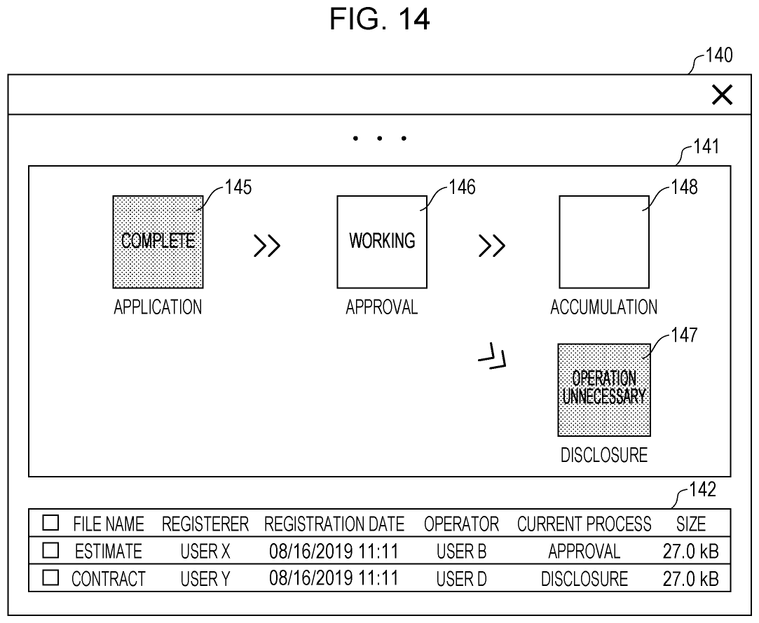

In step S47, the processor 111 changes the icon indicating the process to be performed by the user such that the icon indicates that another branch that does not include the process to be performed by the user has been confirmed as the branch to be followed. A manner in which an icon is displayed in such a way as to indicate that another branch has been confirmed as the branch to be followed is an example of display in a third manner in the present disclosure. In the example illustrated in FIG. 9, the process to be performed by user C for the estimate is the disclosure process. In this case, as illustrated in FIG. 14, the icon 147 indicating the disclosure process is grayed out, and the words “operation unnecessary”, which indicate that the user need not perform a process, are added to the icon 147.

Here, the branch to be followed in the workflow may be changed in accordance with an operation performed by the user after being confirmed. For example, user C may change the branch to be followed to the first branch after the second branch is confirmed as the branch to be followed. As described above, the first branch includes the disclosure process to be performed by user C. After the branch to be followed is changed from the second branch to the first branch, the confirmation information in the workflow information 222 is updated in such a way as to indicate that the branch to be followed has been changed from the second branch to the first branch. In this case, the red solid frame 144 is added to the icon 147 indicating the disclosure process as illustrated in FIG. 13.

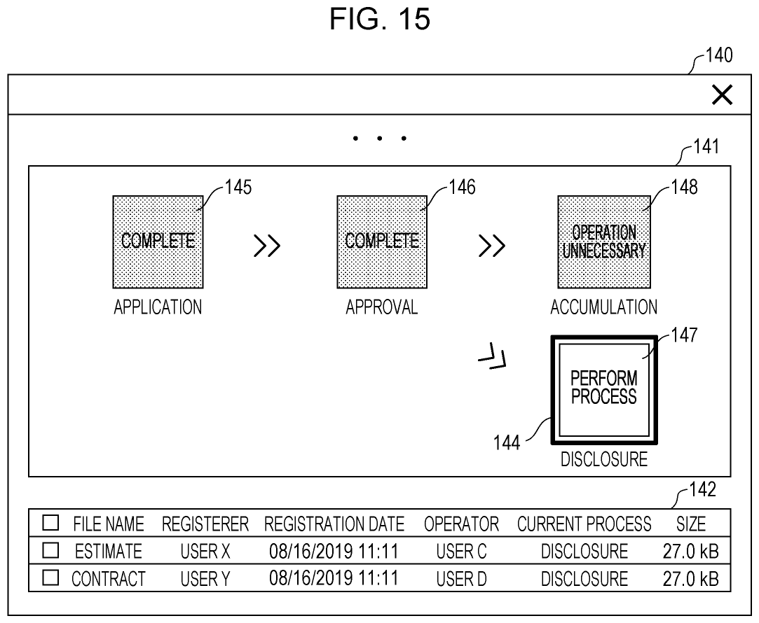

In step S48, the processor 111 causes an icon indicating a process that is being performed for the selected piece of data to reflect a progress state of the process. If the progress information indicates that a progress state of the approval process for the estimate is “processing” as illustrated in FIG. 9, for example, the word “working” indicating that the approval process is being performed is added to the icon 146 indicating the approval process as illustrated in FIG. 13 or 14. If the approval process, which is performed immediately before the disclosure process, is completed after it is confirmed that the user is to perform the disclosure process assigned to the user as described above, the progress information is updated in such a way as to indicate that the approval process has been completed. In this case, as illustrated in FIG. 15, the red solid frame 144 added to the icon 147 indicating the disclosure process flashes, and words “perform process” for encouraging the user to perform the disclosure process are added to the icon 147.

After the process for updating the workflow screen 140 ends, the same operations as in steps S18 and S19 described in the above-described first exemplary embodiment are performed between the server apparatus 110 and the terminal apparatus 120. As a result, the workflow screen 140 updated through the process is displayed on the display unit 125 of the terminal apparatus 120. At this time, a manner in which the icon indicating the process to be performed by the user is displayed changes in accordance with the confirmation state of the branch to be followed.

Before the branch to be followed is confirmed, for example, the workflow screen 140 illustrated in FIG. 12 is displayed on the display unit 125. In the workflow screen 140, the workflow image 141 that reflects the progress states of the application process, the approval process, and the disclosure process for the estimate selected by the user is displayed. Since the first branch, which is one of the branches, includes the disclosure process to be performed by the user, the icon 147 indicating the disclosure process is highlighted in the first manner by adding the red broken frame 143.

If the first branch is confirmed as the branch to be followed in the workflow, a manner in which the icon 147 indicating the disclosure process is displayed changes from that illustrated in FIG. 12 to that illustrated in FIG. 12 since the first branch includes the disclosure process to be performed by the user for the estimate. In this case, as illustrated in FIG. 13, the icon 147 is highlighted in the second manner by adding the red solid frame 144. Here, when the approval process, which is performed immediately before the disclosure process to be performed by the user for the estimate, is completed, a manner in which the icon 147 indicating the disclosure process changes from that illustrated in FIG. 13 to that illustrated in FIG. 15. In this case, as illustrated in FIG. 15, the manner in which the icon 147 is displayed is changed by flashing the red solid frame 144 and adding the words “perform process”.

If the second branch is confirmed as the branch to be followed in the workflow, on the other hand, the manner in which the icon 147 indicating the disclosure process is displayed changes from that illustrated in FIG. 12 to that illustrated in FIG. 14 since the second branch does not include the disclosure process to be performed by the user for the estimate. In this case, the icon 147 is grayed out and words “operation unnecessary” are added to the icon 147 so that the icon 147 indicates that another branch that does not include the disclosure process to be performed by the user has been confirmed as the branch to be followed. If the branch to be followed in the workflow is changed to the first branch after the second branch is confirmed as the branch to be followed, the manner in which the icon 147 indicating the disclosure process is displayed changes from that illustrated in FIG. 14 to that illustrated in FIG. 13. In this case, as illustrated in FIG. 13, the manner in which the icon 147 is displayed is changed by adding the red solid frame 144.

According to the second exemplary embodiment, in the case of a workflow that branches, a manner in which an icon indicating a process to be performed by the user differs between when a branch including the process has been confirmed as a branch to be followed and other cases. The user, therefore, recognizes whether he/she needs to perform the process. In addition, when the branch to be followed in the workflow has not been confirmed, an icon indicating a process to be performed by the user is highlighted in the first manner. The user, therefore, recognizes that he/she might need to perform the process. Furthermore, if a branch including the process to be performed by the user is confirmed as the branch to be followed in the workflow, a manner in which the icon indicating the process is highlighted changes from the first manner to the second manner. The user, therefore, recognizes that it has been confirmed that he/she is to perform the process. Furthermore, if a process immediately before the process to be performed by the user is completed after the branch including the process to be performed by the user has been confirmed as the branch to be followed, the manner in which the icon indicating the process is displayed changes. The user, therefore, recognizes that he/she can now perform the process. Furthermore, if another branch that does not include the process to be performed by the user is confirmed as the branch to be followed in the workflow, the manner in which the icon indicating the process changes from the first manner to a manner indicating that the other branch has been confirmed as the branch to be followed. The user, therefore, recognizes that he/she no longer needs to perform the process. In addition, by displaying the icon inconspicuously, the user need not pay attention to the process that the user no longer needs to perform. Furthermore, if the branch to be followed in the workflow is changed to the branch including the process to be performed by the user after the other branch that does not include the process is confirmed as the branch to be followed, the manner in which the icon indicating the process is displayed changes from the manner indicating that the other branch has been confirmed as the branch to be followed to the second manner. The user, therefore, recognizes that he/she now needs to perform the process as a result of the change to the branch to be followed.

### 3. Modifications

The above-described exemplary embodiments are examples of the present disclosure. The present disclosure is not limited to the above-described exemplary embodiments. The above-described exemplary embodiments may be modified in the following manners and implemented. At this time, two or more of the following modifications may be combined together and implemented.

If an operation returns to an earlier process in a workflow in each of the above-described exemplary embodiments, an icon indicating the process may reflect the fact that the operation has returned to the process. For example, a word indicating that the operation has returned to the process may be added to the icon. An arrow indicating a direction in which the operation has returned may also be added to the icon. At this time, the arrow may have a color, a shape, or a size different from an arrow indicating a normal proceeding direction of the workflow.

If a process immediately before a process to be performed by the user is completed in the above-described first exemplary embodiment, a manner in which an icon indicating the process is displayed may be changed as in the second exemplary embodiment. When the approval process is completed in the example illustrated in FIG. 8, the red solid frame 138 added to the icon 137 indicating the disclosure process to be performed by the user may flash and the words “perform process” may be added to the icon 137. A change to the manner in which the icon 137 indicating that the process immediately before the process to be performed by the user has been completed is displayed is not limited to the flashing of the red solid frame 138 and the addition of the words “perform process”. For example, the icon 137, or a color, a shape, or a size of the red solid frame 138 added to the icon 137, may be changed, or another additional image, another word, a sign, or a number may be added to the icon 137, instead.

In the above-described second exemplary embodiment, the branching of a workflow is not limited to branching of processes. If candidates for an operator are allocated to one of processes included in a workflow, for example, the candidates may be branches, instead. If the operator to perform the process has not been confirmed in this case, an icon indicating the process may be highlighted in the first manner. If the user is confirmed as the operator to perform the process, the icon indicating the process may be highlighted in the second manner. If another user is confirmed as the operator to perform the process, the icon indicating the process may be displayed in such a way as to indicate that the other user has been confirmed as the operator.

In the above-described exemplary embodiments, a manner in which a workflow image that reflects a progress state of a process is displayed is not limited to the graying out or the addition of the word “working”. For example, another additional image, another word, a sign, or a number indicating the progress state of the process may be added to the icon, or the color, shape, or size of the icon may be changed, instead.

In the above-described exemplary embodiments, a method for highlighting an icon is not limited to the addition of a frame. For example, an additional image, a word, a sign, or a number may be added to the icon so that the icon becomes conspicuous, or the color, shape, or size of the icon may be changed, instead. In addition, an icon indicating a process to be performed by the user may be changed to a face image of the user stored in the memory 112 in advance, instead. The face image may be one that has been captured or an illustration.

In the above-described second exemplary embodiment, a difference between the first manner and the second manner in which an icon is highlighted is not limited to the type of frame added to the icon. For example, a color, thickness, size, or decoration of a frame added to the icon may be different between the first manner and the second manner in which the icon is highlighted, instead. Alternatively, a word or an additional image added to the icon or the color, shape, or size of the icon may be different. In addition, a method for inconspicuously displaying an icon is not limited to the graying out of the icon. A color, a shape, or a size of an icon may be changed such that the icon becomes inconspicuous, or an additional image or a word may be added to the icon, instead.

In the above-described exemplary embodiments, processes included in a workflow are not limited to those described above. Any process may be included in a workflow insofar as the process is processing of data.

In the above-described exemplary embodiments, the components that perform processes in the workflow system 100 are examples, and the components used are not limited to these examples. For example, at least a part of the processes performed in the workflow system 100 may be performed in another apparatus, instead. In addition, the order in which the processes are performed in the workflow system 100 in the above-described exemplary embodiments is an example, and the order may be changed insofar as no contradiction is caused.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The present disclosure may be implemented in programs to be executed in the server apparatus 110 and the terminal apparatus 120. The server apparatus 110 and the terminal apparatus 120 are examples of a computer in the present disclosure. These programs may be downloaded over a communication network such as the Internet, or stored in a computer readable storage medium, such as a magnetic storage medium (magnetic tape, a magnetic disk, etc.), an optical storage medium (an optical disc, etc.), a magneto-optical storage medium, or a semiconductor memory, and provided.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
perform control in such a way as to display a workflow image indicating a series of processes included in a workflow and a list of data to be processed in the workflow, and
cause, in a case where a piece of data is selected on the list of data, the workflow image to reflect a progress state of processing of the selected piece of data.

2. The information processing apparatus according to claim 1,
wherein the processor is configured to highlight a target part, which is a target process to be performed by a user, in the workflow image.

3. The information processing apparatus according to claim 2,
wherein the processor is configured to, if the workflow branches, display the target part differently between a case where a target branch, which includes the target process, is selected from a plurality of branches and other cases.

4. The information processing apparatus according to claim 3,
wherein the processor is configured to, in a case where a branch to be followed has not been determined, highlight the target part in a first manner.

5. The information processing apparatus according to claim 4,
wherein the processor is configured to, in a case where the target branch has been determined, change a manner in which the target part is highlighted from the first manner to a second manner, which is different from the first manner.

6. The information processing apparatus according to claim 4,
wherein the processor is configured to, if an other branch including a process different from the target process is determined among the plurality of processes as the branch to be followed, change a manner in which the target part is highlighted from the first manner to a third manner, which indicates that the other branch has been determined as the branch to be followed.

7. The information processing apparatus according to claim 6,
wherein the processor is configured to, if the branch to be followed is changed from the other branch to the target branch, change the manner in which the target part is highlighted from the third manner to a second manner, which is different from the first manner.

8. The information processing apparatus according to claim 2,
wherein the processor is configured to, in a case where a process immediately before the target process has been completed, change a manner in which the target part is displayed.

9. A non-transitory computer readable medium storing a program causing a computer to execute a process comprising:
performing control in such a way as to display a workflow image indicating a series of processes included in a workflow and a list of data to be processed in the workflow, and
causing, in a case where a piece of data is selected on the list of data, the workflow image to reflect a progress state of processing of the selected piece of data.

10. An information processing apparatus comprising:
means for performing control in such a way as to display a workflow image indicating a series of processes included in a workflow and a list of data to be processed in the workflow, and
means for causing, in a case where a piece of data is selected on the list of data, the workflow image to reflect a progress state of processing of the selected piece of data.
